(19) United States
(12) Patent Application Publication
(10) Pub. No.: US 2007/0131150 A1
(43) Pub. Date: Jun. 14, 2007

(54) Apparatus and method of producing carbide

(76) Inventor: Noriyuki Yamazaki, Shiga (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/564,957

(22) PCT Filed: Jul. 18, 2003
(86) PCT No.: PCT/JP03/09213

§ 371 Date: Jun. 12, 2006

(51) Int. Cl. F23G 5/12; A47J 36/00

(52) U.S. Cl. 110/229; 110/246

(57) ABSTRACT

The invention relates to a carbonization plant and carbonization process that is able to suppress bridges of carbonized products from being generated in a rotary furnace body while the carbonized product is suppressed from adhering, and by which the carbonized product is efficiently produced with a uniform and good quality. The carbonization plant comprises a heating furnace 2, a rotary furnace body 4 freely rotatably supported in the heating furnace, a rotary drive means 5 for rotating the rotary furnace body, a scratch-up means (scratch-up member 6) provided at an inner face side of the rotary furnace body for scratching up a charged material (waste tire chips and/or their carbonized chips) in the rotary furnace body by rotation of the rotary furnace body, and a vibration means (chane-like members 7a, 7b) for vibrating the rotary furnace body.

### BACKGROUND OF THE INVENTION

1. Field of the Invention

The invention relates to a carbonization plant and carbonization process. In particular, the invention relates to a carbonization plant that is able to suppress bridges of carbonized products from being generated in a rotary furnace body while the carbonized product is suppressed from adhering, and by which the carbonized product is efficiently produced with a uniform and good quality, and a carbonization process using the carbonization plant.

The invention provide a technology that is effectively used for producing activated carbon having a uniform and good quality using waste tires.

2. Description of the Related Art

Although the quantity of waste tires is rapidly increasing as a result of spreading uses of automobiles, it has been difficult to dispose of all the waste tires due to limited ability of disposal plants, and effective recycling methods of the waste tires should be developed. Based on such situation, various technologies have been proposed for producing activated carbon using the waste tires as starting materials (see, for example, Japanese Patent Publication Laid-Open (JP-A) Nos. 9-227112, 2003-64372 and 4-292409).

For example, JP-A No. 9-227112 discloses a rotary kiln carbonization plant for producing activated carbon providing a cylindrical furnace main unit comprising a spiral protrusion on the inner circumference of the furnace, whereby pulverized chips of the waste tires charged into the main unit of the furnace from one end thereof is agitated with a spiral protrusion and conveyed toward the other end thereof by rotating the furnace main unit, and the chips are heated by blowing hot air into the furnace.

While the chips are agitated by being scratched up with the spiral protrusion in the art described in JP-A No. 9-227112, the chips are not sufficiently agitated by this method, and bridges (masses) of the chips are formed to fail in obtaining activated carbon having a uniform and good quality (for example a high specific surface area). Moreover, the carbonized product is so liable to adhere on the spiral protrusion that it should be frequently cleaned. Since a so-called gas activation method (steam activation method) is employed, it is also a problem that applicable raw materials are restricted and the production process is complicated. Accordingly, this method is not suitable for producing activated carbon using the waste tire as the starting material.

The inventors of the invention has disclosed in JP-A No. 2003-64372 an art for obtaining activated carbon using a plant comprising a hexagonal cylinder of a chip holder (a rotary furnace body) freely rotatably supported in the heating furnace and a rotary drive unit for rotating the chip holder, whereby a given quantity of the waste tire charged into the chip holder is heated while the material remains to contact an alkali metal hydroxide to produce activated carbon. Activated carbon having a relatively good quality can be obtained using the waste tire as the starting material.

However, while the chips are agitated by being scratched up at the corners of the polygonal (hexagonal) chip holder 4 in JP-A No. 2003-64372, the chips cannot be sufficiently agitated and the bridges of the carbonized product are also formed to fail in obtaining activated carbon having a uniform and good quality. Moreover, since many penetration holes 43 are formed in the chip holder in order to allow the chips to contact the alkali metal hydroxide, the carbonized product adheres in the penetration holes 43 to force the chip holder to be frequently cleaned. The entire plant becomes relatively expensive since the chip holder should be made of an expensive material for maintaining a heat resistant strength.

Since the plant disclosed in JP-A No. 2003-64372 comprises the polygonal (hexagonal) chip holder 4, a bucket 3 for storing the alkali metal hydroxide and inner frames 20 for dividing a heating chamber, the chip holder inevitably becomes to have a complex multi-cylinder structure to render the entire plant to be expensive. Productivity of the plant is low since the quantity of the chips charged in the chip holder is small relative to the entire size of the plant.

Charge and discharge procedures are complicated in the plant described in JP-A No. 2003-64372, since the chips are charged by plate members 44a of the chip holder 4 while a cap 8 is removed from the furnace main unit 7 constituting the heating furnace 2, and the carbonized product is discharged by turning over a bucket 3 together with the chip holder 4.

JP-A No. 4-292409 discloses an art in which the waste tires are pulverized into chips, and activated carbon is produced by heating a mixture of the chips and alkali metal hydroxide. However, further reduction of the production cost and higher quality of activated carbon obtained have been required since the chemical (potassium hydroxide) used is expensive in the process disclosed in JP-A No. 4-292409.

### SUMMARY OF THE INVENTION

The object of the invention performed by taking the situations above into consideration is to provide a carbonization plant and carbonization process that is able to suppress bridges of carbonized products from being generated in a rotary furnace while the carbonized product is suppressed from adhering, and by which the carbonized product is efficiently produced with a uniform and good quality.

The present invention is represented as follows.

1. A carbonization plant comprising a heating furnace, a rotary furnace body supported in the heating furnace to be freely rotatable, a rotary drive means for rotating the rotary furnace body, and a vibration means for vibrating said rotary furnace body.

2. A carbonization plant comprising a heating furnace, a rotary furnace body supported in the heating furnace to be freely rotatable, a rotary drive means for rotating the rotary furnace body, a scratch-up means provided at an inner face side of said rotary furnace body for scratching up a charged material in the rotary furnace body by rotation of said rotary furnace body, and a vibration means for vibrating said rotary furnace body.

3. The carbonization plant according to above 2, wherein said heating furnace is supported to be freely tiltable and further comprising a tilt drive means for tilting the heating furnace and said rotary furnace body together.

4. The carbonization plant according to above 3, wherein said tilt drive means is constructed so that the rotary furnace body is inclinable together with said heating furnace depending on the charged amount of said charged material.

5. The carbonization plant according to above 2, wherein said vibration means comprises one or a plurality of chain-like members, at least one end thereof being fixed on the inner face side of said rotary furnace body.

6. The carbonization plant according to above 5, wherein said chain-like members is disposed with a given interval in a direction of rotation of said rotary furnace body,

the one chain-like member of said chain-like members disposed in adjoining relation to one another being supported at one end thereof, and

the other chain-like member of the chain-like members disposed in adjoining relation to one another being supported at both ends thereof.

7. The carbonization plant according to above 2, wherein said scratch-up means comprises one or a plurality of scratch-up members having a scratch-up part elongating along a shaft center (C) of said rotary furnace body and a crossing part connected to the scratch-up part and elongating in a direction crossing the shaft center (C) of said rotary furnace body with a given tilt angle (α),

said crossing part being disposed close to an opening port provided at one end of said rotary furnace body.

8. The carbonization plant according to above 2, wherein said rotary furnace body is formed into a round cylinder.

9. The carbonization plant according to above 2,

wherein a gas feed pipe elongating along the shaft center (C) of the rotary furnace body is connected at one end of said rotary furnace body for feeding an inert gas, and

wherein one end of an exhaust pipe elongating along the shaft center (C) of the rotary furnace body is connected to the other end of said rotary furnace body for discharging an exhaust gas generated in the rotary furnace body.

10. The carbonization plant according to above 9 further comprising a deodorizing device connected at the other end of said exhaust pipe for deodorizing said exhaust gas.

11. The carbonization plant according to above 10, wherein said deodorizing device is connected at the other end of said exhaust pipe through a refrigerator for cooling said exhaust gas.

12. The carbonization plant according to above 10, wherein said deodorizing device comprises a heating means, a washing mechanism with water for washing said exhaust gas heated with the heating means, and drainage retrieval means for retrieving the drainage issued by washing with water.

13. The carbonization plant according to above 2, wherein said charged material comprises waste tire chips formed by pulverizing the waste tire, and/or carbonized chips formed by heating the waste tire chips.

14. A carbonization process using the carbonization plant according to above 1 comprising a heating step for heating charged material in the rotary furnace body by rotating the rotary furnace body in the heating furnace,

said rotary furnace body being vibrated with a vibration means in the heating step.

15. The carbonization process using the carbonization plant according to above 2 comprising a heating step for heating charged material in the rotary furnace body by rotating the rotary furnace body in the heating furnace,

said charged material being scratched up by a scratch-up means and said rotary furnace body being vibrated with a vibration means in the heating step.

16. The carbonization process according to above 15 further comprising a step for immersing said charging material in an alkali metal carbonate solution before being charged in said rotary furnace body,

said charged material immersed in said alkali metal carbonate solution being heated by mixing with an alkali metal hydroxide in said rotary furnace body in said heating step, and

said alkali metal carbonate solution being a drainage retrieved after washing an exhaust gas generated in said heating step with water.

17. The carbonization process according to above 15, wherein a carbonized product is formed by heating said charged material in said rotary furnace body in said heating step, and the carbonized product is converted into activated carbon by mixing with the alkali metal hydroxide with heating.

18. The carbonization process according to above 15, wherein said charged material comprises the waste tire chips obtained by pulverizing the waste tire, and/or the carbonized chips obtained by heating the waste tire chips.

According to the carbonization plant of the invention, the rotary furnace body is vibrated with a vibration means when the rotary furnace body is rotated in the heating furnace. This allows bridges of the carbonized product to be suppressed from being generated in the rotary furnace body while the carbonated product is suppressed from adhering in the rotary furnace body to enable the carbonated product to be efficiently produced with a uniform and good quality. Consequently, the entire plant is constructed with a simple and inexpensive structure.

According to another carbonization plant of the invention, the charged material is scratched up with a scratch-up means by rotating the rotary furnace body in the heating furnace while the rotary furnace body is vibrated with a vibration means. This allows the charged material to be more reliably agitated by being scratched up to enable bridges of the carbonized product to be prevented from being generated while the carbonized product is suppressed from adhering in the rotary furnace body. Consequently, a carbonized product having a uniform and good quality can be efficiently produced while the entire plant has a simple and inexpensive structure.

When the plant further comprises a tilt drive means, the rotary furnace body and the furnace may be tilted together so that the tilt angle is suitable for various processing such as charge of the charging material and discharge of the carbonized product.

When the tilt drive means is constructed so that the rotary furnace body and the heating furnace are tilted together depending on the quantity of the charged material, the rotary furnace body and the heating furnace may be tilted together so that the tilt angle is suitable for the quantity of the charging material.

When the vibration means comprises a chain-like member, the rotary furnace body may be vibrated with an appropriate intensity by permitting the chain-like member to contact the inner circumference face of the rotary furnace body by taking advantage of rotation of the rotary furnace body.

When the chain-like member is disposed with a given interval along the direction of rotation of the rotary furnace body, and when one of the chain-like members disposed in adjoining relation to one another is supported at one end thereof, and the other chain-like member of the chain-like members disposed in adjoining relation to one another is supported at both ends thereof, the scratch-up action by the scratch-up means may be facilitated with the chain-like member supported at one end thereof, and an appropriate intensity of vibration may be applied to the rotary furnace body with the chain-like members supported at one end and supported at both ends thereof.

When the scratch-up means comprises a scratch-up member having a scratch-up part and a crossing part, and when the crossing part is disposed close to feed and discharge port provided at one end of the rotary furnace body, the charged material is suppressed from moving in the direction of the feed port by the crossing part when the rotary furnace body is rotating forward, while the carbonized product is actively transferred in the direction of the discharge port by the crossing part when the rotary furnace body is inversely rotating.

A larger quantity of the material may be charged in one batch by forming the rotary furnace body into a cylindrical shape.

When the gas feed pipe is connected to one end of the rotary furnace body, and when one end of the exhaust pipe for discharging the exhaust gas is connected to the other end of the rotary furnace body, the inert gas may be readily supplied into the rotary furnace body while the exhaust gas generated in the rotary furnace body is readily exhausted.

The exhaust gas generated in the rotary furnace body may be readily deodorized by further providing a deodorizing device.

The exhaust gas may be deodorized after retrieving oily components by connecting the deodorizing device at the other end of the exhaust pipe through the refrigerator for cooling the exhaust gas.

The exhaust gas generated in the rotary furnace body may be reliably deodorized by allowing the deodorizing device to provide a heating unit, a washing unit with water and a drainage retrieval unit. The drainage after washing with water may be retrieved and recycled.

When the charged material comprises waste tire chips and/or carbonized chips, activated carbon having a uniform and good quality may be efficiently produced using the waste tire as a starting material.

According to the carbonizing process of the invention, the rotary furnace body may be vibrated with the vibration means by allowing the rotary furnace body to rotate in the heating furnace. This permits bridges of the carbonized product to be prevented from being generated in the rotary furnace body while the carbonized product is suppressed from adhering in the rotary furnace body to consequently permit the carbonized product to be produced with a uniform and good quality.

According to another carbonization process of the invention, the charged material is scratched up with the scratch-up means by rotating the rotary furnace body in the heating furnace, and the rotary furnace body is vibrated with the vibration means. This permits the charged material to be more reliably agitated by being scratched up to enable bridges of the carbonized product to be prevented from being generated in the rotary furnace body while the carbonized product is suppressed from adhering in the rotary furnace body. Consequently, the carbonized product may be efficiently produced with a uniform and good quality.

When the carbonization process further comprises a step for immersing a charging material in an alkali metal carbonate solution before being charged in the rotary furnace body, and when the charged material immersed in the alkali metal carbonate solution is heated by mixing with an alkali metal hydroxide in the rotary furnace body in the heating step, and the alkali metal carbonate solution is a drainage retrieved after washing an exhaust gas generated in the heating step with water, the amount of use of the alkali metal hydroxide may be reduced by utilizing the drainage after washing with water to enable the production cost to be largely reduced.

The production efficiency may be largely improved by heating the charged material in the rotary furnace body to form the carbonized product, and the carbonized product is converted into activated carbon by mixing the carbonized product and an alkali metal hydroxide with heating.

Activated carbon having a uniform and good quality may be produced using the waste tire as a material when the charged material is the waste tire chips and/or carbonized chips thereof.

### BRIEF DESCRIPTION OF THE DRAWINGS

FIG. 1 is a cross section of the carbonization plant according to the invention;

FIG. 2 is a cross section along the line II-II in FIG. 1;

FIG. 3 is a magnified drawing of the main part in FIG. 1;

FIG. 4 is a cross section of the main part for describing the deodorizing device;

FIG. 5 is a drawing for describing the scratch-up action of the charged material;

FIG. 6 is another drawing for describing the scratch-up action of the charged material; and

FIG. 7 is a flow chart for describing another embodiment for tilting the heating furnace.

### DESCRIPTION OF THE INVENTION

(Carbonization Plant)

The carbonization plant of the invention comprises a heating furnace, rotary furnace body, rotary drive device and vibration device. The carbonization plant may further comprise, for example, a scratch-up device, tilt-drive device, deodorizing device and refrigerator.

The structure, shape and size of the “heating furnace” are not particularly specified. The heating furnace may comprise, for example, a heating furnace main unit in which a heating chamber is formed, and a heating unit attached to the heating furnace main unit for heating the heating chamber (for example a combustion burner). The heating furnace may be supported so as to be freely tiltable around a horizontal shaft in order to tilt the heating furnace at a desired tilt angle suitable for charging a charged material and for discharging a carbonized product. While the heating furnace main unit may be formed into a rectangular cylinder, it is preferably formed into a round cylinder considering the volume and machinability thereof.

The structure, shape and size of the “rotary furnace body” are not particularly specified so long as it is supported in the heating furnace to be freely rotatable. The rotary furnace body is usually supported to be freely rotatable around a horizontal shaft. Open and close doors for charging and discharging may be provided at the circumference face of the rotary furnace body. Alternatively, one end of the rotary furnace body may be formed as a charge and discharge opening port. The rotary furnace body may also comprise, as will be described below, a large diameter cylinder, a tapered part connected to one end of the large diameter cylinder to as to be conically tapered, and a small diameter cylindrical port connected to the other end of the tapered part. While the rotary furnace body may be formed as a rectangular cylinder, it is preferably formed into a round cylinder considering the volume and machinability. The charged material is scratched up at the cross point of each circumference face of the rotary furnace main unit by rotating the rotary furnace body when the rotary furnace body is formed into the rectangular cylinder.

A gas feed pipe for feeding an inert gas (for example nitrogen, argon or helium gas), which is elongated along the shaft center C of the rotary furnace body, may be connected at one end of the rotary furnace body, and an exhaust pipe for discharging an exhaust gas generated in the rotary furnace body, which is also elongated along the shaft center C of the rotary furnace body, may be connected to the other end of the rotary furnace body.

The structure and driving modes of the “rotary drive device” are not particularly specified so long as it is able to rotate the rotary furnace body. For example, the rotary drive device comprises a control unit, a drive unit controlled with the control unit (for example a driving motor or cylinder), and a power transfer mechanism for transferring a rotary power of the driving unit to the rotary furnace body.

The structure and vibration modes of the vibration means are not particularly specified, so long as the means is able to vibrate the rotary furnace body. The vibration means may comprise an exclusive use driving unit (for example a driving motor or cylinder), and a vibrating member for vibrating the rotary furnace body in contact with the rotary furnace body by means of the driving unit. The vibrating means preferably has the vibrating member for vibrating the rotary furnace body in contact with the rotary furnace body by the rotation of the rotary furnace body for making the structure simpler and cheaper. While the vibrating member may be provided, for example, at the outside of the rotary furnace body, it is preferably provided inside of the rotary furnace body for applying an appropriate intensity of vibration. An example of the vibrating member is a spherical member or a block member freely movable (rotatable) by being placed within the rotary furnace body. The vibrating member is preferably a chain-like member, a rope member (for example a wire rope) or a rod member at least one end of which is fixed for applying an appropriate intensity of vibration. The chain-like member, one end of which is fixed at the inner face of the rotary furnace member, is particularly preferable. The chain-like member may be supported at one end by being fixed at the inner face of the rotary furnace member, or at both ends being fixed at the inner face of the rotary furnace member. The chain-like member may comprise sequentially coupled many ring members, or many sequentially coupled members supported to be freely rotatable.

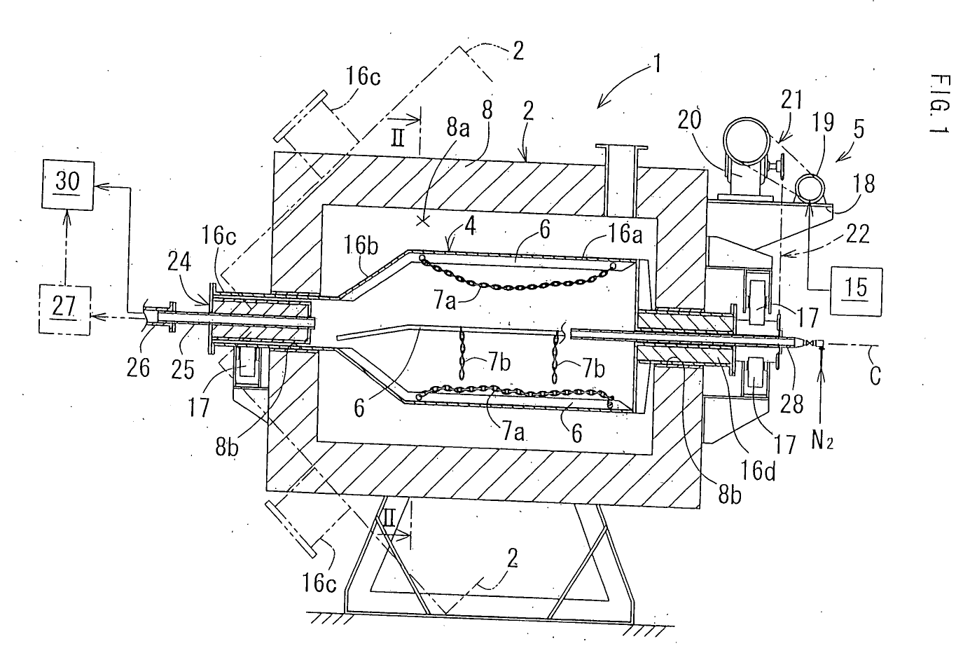

The plural chain-like member may be disposed with a given interval (preferably with an equal interval) along the direction of rotation of the rotary furnace body. The end of these plural chain-like members may be fixed to a scratch-up member to be described below. These plural chain-like members may be supported at one end thereof or at both ends thereof, or may be a combination of the chain-like members supported at one end and both ends thereof. Preferably, one of the chain-like members disposed in adjoining relation in the direction of rotation of the rotary furnace body is supported at one end thereof, and the other chain-like member is supported at both ends thereof as will be described in the examples hereinafter, in order to apply an appropriate intensity of vibration. Preferably, the plural chain-like members supported at one end are disposed with a given interval along the shaft center C of the rotary furnace body, while the chain members supported at both sides are hung along the shaft center C of the rotary furnace body with a given looseness (see FIG. 1).

The structure, shape and mode of installation of the “scratch-up means” are not particularly specified, so long as it is provided at the inner face side of the rotary furnace body and is able to scratch up the charged material by rotating the rotary furnace body. This scratch-up means may be composed of a scratch-up member elongating along the shaft center C of the rotary furnace body. The shape of the scratch-up member may be linear, deflected, curved or spiral. The cross sectional shape of the scratch-up member may be a rectangular, deflected, curved or irregular. Steels and ceramics may be used as the material of the scratch-up member. The scratch-up member may comprise a heat-resistant coating layer (preferably an alumina coating layer) on the surface. The plural scratch-up members may be disposed along the direction of rotation of the rotary furnace member with a given interval (preferably with an equal interval) apart.

The scratch-up member may comprise a scratch-up part elongating along the shaft center C of the rotary furnace body, and a crossing part connected to the scratch-up part and elongating in a direction crossing with a given tilt angle to the shaft center C of the rotary furnace body and the direction of rotation of the rotary furnace body. The crossing part may be disposed close to the opening provided at one end of the rotary furnace body. This crossing part permits the charged material in the rotary furnace body to be suppressed from moving toward the opening port side when the rotary furnace body is rotating forward, while the carbonized product is actively transferred toward the discharge port when the rotary furnace body is inversely rotating, when the crossing angle and the direction of rotation are properly adjusted.

The structure and the mode of “tilt drive means” are not particularly specified, so long as the heating furnace and the rotary furnace body are able to be tilted together with a given tilt angle. The tilt drive means may comprise a control unit, a driving unit (for example a driving motor and cylinder) controlled with the control unit, and a power transfer mechanism for transferring the driving power of the driving unit to the rotary furnace body. The tilt drive means may be constructed so that the heating furnace and rotary furnace body are tiltable together with a desired tilt angle for directing the opening of the rotary furnace body in a substantially horizontal direction (for example 0° ), in a tilt angle for directing the opening of the rotary furnace body aslant upward from the horizontal direction (for example 45°), or in a tilt angle for directing the opening of the rotary furnace body aslant downward from the horizontal direction (for example −45°) as will be described hereinafter. The “tilt angle” denotes a crossing angle between the horizontal direction and shaft center C of the rotary furnace body.

The tilt drive means may be constructed so as to be able to tilt the heating furnace and rotary furnace body together, so that the tilt angle is adjustable depending on the quantity of the charged material. The heating furnace and rotary furnace body are tilted with a tilt angle (for example 0° ) for substantially directing the opening of the rotary furnace body in the horizontal direction when the quantity of the charged material is below a prescribed quantity of charging (designed quantity), while heating furnace and rotary furnace body are tilted with a tilt angle (for example 3°) for directing the opening of the rotary furnace body to be aslant upward from the horizontal direction when the quantity of the charged material exceeds the prescribed quantity of charging. Accordingly, the charged material can be reliably prevented from leaking out of the opening port of the rotary furnace body even when a large quantity of the material is charged.

The structure and mode of deodorization of the “deodorizing device” are not particularly specified, so long as it is connected to one end of the exhaust pipe to be freely attachable and detachable, and is able to deodorize the exhaust gas. The deodorizing device may comprise a heating unit (for example a combustion burner), a washing mechanism for washing the exhaust gas heated with the heating unit with water, and a drainage retrieval unit for retrieving the drainage generated from the washing mechanism. The exhaust gas generated by heating a mixture of the charged material and an alkali metal hydroxide (for example potassium hydroxide and/or sodium hydroxide) may be reliably deodorized, and the drainage in deodorizing with water (for example aqueous potassium carbonate solution and/or aqueous sodium carbonate solution) may be retrieved to recycle it as a solution for immersing the material before charging. This washing mechanism may comprise a water sprinkle nozzle to which city water is supplied, and an umbrella-like member for forming a running water curtain formed by guiding sprinkled water from the sprinkle nozzle. The exhaust gas heated with the heating unit may be emitted to open air after washing the exhaust gas with water by passing through the running water curtain. The deodorizing device may comprise a heat resistant catalyst provided at the halfway of an exhaust passageway.

The structure and mode of cooling of the “refrigerator” are not particularly specified, so long as it is connected at one end of the exhaust pipe to be freely attachable and detachable so as to be able to cool the exhaust gas. The deodorizing device is connected to the refrigerator so as to be freely attachable and detachable. The refrigerator is preferably water-cooled in order to efficiently retrieve oily components in the exhaust gas.

The origin and quantity of charging of the “charged material” are not particularly specified, so long as it is able to be charged in the rotary furnace body. Examples of them include waste tires, waste plastics, waste wood chips, waste fabrics, waste paper sheets and sludge. The charged material may be waste tire chips formed by pulverizing the waste tires, and/or a carbonized products formed by heating the waste tire chips (either powder or chips available). The waste tire chips are pulverized into a desired size using a known pulverizer, and is subjected to a steel removing treatment using a magnetic separator. The shape of the waste tire chip may be a rectangular block or fibrous. The shape and size of the powder and chips are not particularly restricted, and both the powder and chips are commonly named as “chips”.

The carbonized products produced by the carbonization plant of the invention include carbon black, activated carbon and graphite.

(Carbonization Process)

The carbonization process according to the invention denotes the carbonization process using the carbonization plant as described above, and comprising the following heating steps. The carbonization process may further comprise the following immersion step and washing step. For example, the charged material and carbonized material described in the carbonization plant above may be used for the carbonized product produced by the carbonization process.

The “heating step” include a step for vibrating the rotary furnace body by means of the vibrating device when the charged material in the rotary furnace body is heated by rotating the rotary furnace body in the heating furnace. The charged material may be scratched up with the scratch-up means in the heating step, while the rotary furnace body is vibrated with the vibrating means. While the heating condition in the heating step is not particularly specified, the heating temperature is 400 to 550° C., preferably 480 to 520° C., for obtaining carbon black. On the other hand, the heating temperature is 800 to 950° C., preferably 880 to 920° C., for obtaining activated carbon. The heating atmosphere is preferably an inert gas atmosphere (nitrogen, argon or helium atmosphere), and the nitrogen atmosphere is particularly preferable since the specific surface area of activated carbon obtained becomes large.

The heating step may comprise the step of either (1) forming a carbonized product such as carbon black by heating a non-carbonized material such as waste tire chips as the charging material, (2) forming a carbonized product such as activated carbon or graphite by heating a carbonized material such as carbon black as the charging material, or (3) forming a carbonized product such as activated carbon or graphite by heating a non-carbonized material such as the waste tire chips. Activated carbon may be produced when the charging material is mixed with an alkali metal hydroxide in the step (2).

A carbonized product such as carbon black may be formed by heating the charged material such as the waste tire chips in the rotary furnace body followed by a step for forming activated carbon by heating a mixture of the carbonized product and an alkali metal hydroxide in the heating step. Since activated carbon can be obtained from a non-carbonized material using one unit of the carbonization plant, the production efficiency can be extremely improved as compared with the conventional process in which two units of the carbonization plant and an activation device are used together. It is particularly preferable that the heating step comprises the steps of coupling the exhaust pipe connected to the rotary furnace body with the deodorizing device, forming a carbonized product (for example the above carbonized chips) by heating the charged material (for example the above waste tire chips) in the rotary furnace body, connecting the exhaust pipe coupled with the rotary furnace body to the deodorizing device through the refrigerator, and forming activated carbon by heating a mixture of the carbonized product and alkali metal hydroxide.

The charging material before charging in the rotary furnace body is immersed in an aqueous alkali metal carbonate solution (for example an aqueous potassium or sodium carbonate solution) in the “immersing step”. The immersion condition is not particularly specified, and may be agitation at room temperature or by heating. Providing the immersion step permits contaminants such as oily components adhered on the charging material to be removed before charging, while the amount of use of the alkali metal hydroxide may be reduced by allowing the alkali metal carbonate to adhere on the surface of the charging material when a mixture of the charged material and alkali metal hydroxide (for example potassium or sodium hydroxide) is heated thereafter. Preferably, the aqueous alkali metal carbonate solution is an aqueous potassium carbonate solution, and the aqueous alkali metal hydroxide solution is an aqueous potassium hydroxide solution, in order to obtain better quality of activated carbon and in order to suppress activated carbon from adhering on the rotary furnace body.

While the “aqueous alkali metal carbonate solution” may be prepared by dissolving an alkali metal carbonate in an aqueous solvent such as water, the washing drainage retrieved after washing the exhaust gas generated in the heating step with water, washing drainage retrieved in the washing step to be described hereinafter, and a mixed drainage retrieved in both steps may be used. The drainage generated in the production step of activated carbon may be effectively recycled by these steps. Since the alkali metal carbonate is formed in the heating step of a mixture of the charged material and alkali metal hydroxide, the drainage containing the alkali metal carbonate is formed by washing the heated exhaust gas with water, or by washing the carbonized product after heating.

The “washing step” is a step for washing the carbonized product obtained in the heating step with water. Providing the washing step permits components remaining on the surface of the carbonized product (such as crude activated carbon) obtained to be removed. The washing methods and conditions are not particularly restricted, and aqueous solvents such as water and warm water may be used as washing liquids. The drainage of washing containing the alkali metal carbonate may be retrieved and recycled by this step. It is preferable to use an acidic solution as the washing liquid and to immerse activated carbon therein, since alkaline components such as potassium carbonate remaining on the surface of the carbonized product (crude activated carbon) can be removed by neutralization while heavy metal components such as zinc remaining in the chips may be also removed. Drying conditions of activated carbon after washing with water in this washing step are not particularly restricted, and the method may be spontaneous drying or heat drying using a dryer.

Best Mode for Carrying out the Invention

(1) Construction of Carbonization Plant

The invention will be described in detail with reference to the drawings.

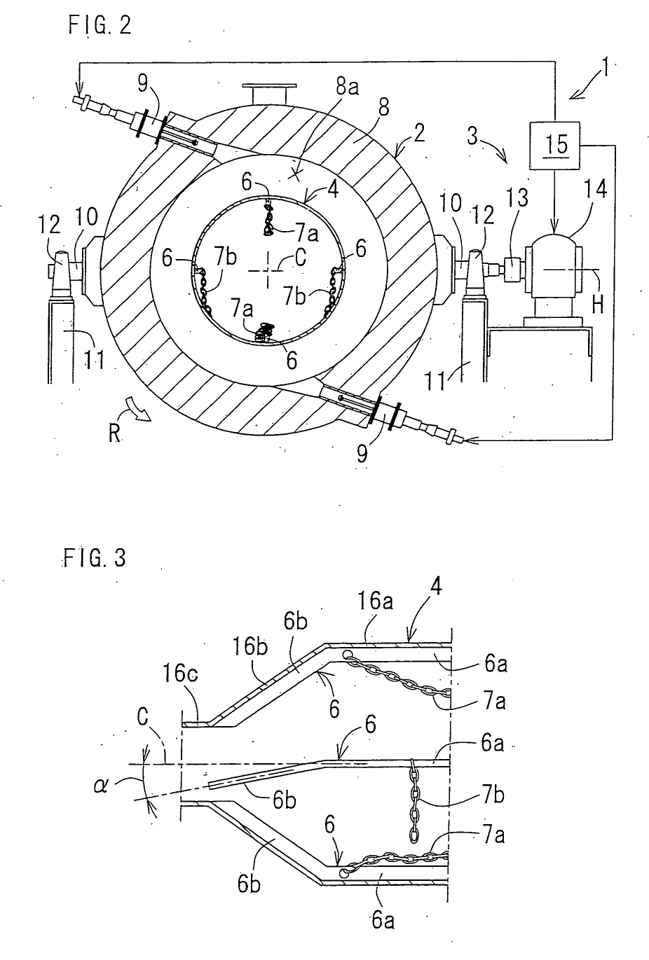

As shown in FIGS. 1 and 2, the carbonization plant 1 according to the invention basically comprises a heating furnace 2 supported around a horizontal shaft to be freely tiltable, a tilt-drive device 3 for tilting the heating furnace 2, a rotary furnace body 4 supported around a shaft center C in the heating furnace 2 to be freely rotatable, a rotary drive device 5 for rotating the rotary furnace body 4, a scratch-up member 6 for scratching up a material charged in the rotary furnace body 4 by rotating the rotary furnace body 4, and a chain members 7a and 7b for vibrating the rotary furnace body 4.

The heating furnace 2 comprises a cylindrical heating furnace main unit 8 in which a heating chamber 8a is formed. A pair of combustion burners 9 are provided at the upper part and lower part on the circumference face of the heating furnace main unit 8. The temperature in the heating chamber 8a can be arbitrarily increased or decreased by controlled heating of the pair of the combustion burners 9 with a control device unit 15. A pair of supporting shafts 10 are provided so as to be protruded out of the right and left sides on the circumference face of the heating furnace main unit 8, and the pair of these supporting shafts 10 are supported to be freely tiltable with a pair of left and right supporting frames 11 provided on a floor by means of bearings 12. A driving shaft of a tilt-drive motor 14 incorporating a decelerating mechanism and brake mechanism (not shown) is coupled with one of the supporting shafts 10 (right side in the drawing in FIG. 2) via a coupling 13. Accordingly, the heating furnace 2 and rotary furnace main unit 8 are tiltable together at a desired tilt angle by controlling the tilt-drive motor 14 with the control unit 15. Actually, the heating furnace 2 and rotary furnace main unit 8 are tilted together so that the shaft center C of the rotary furnace main unit 8 is in a horizontal direction (as shown by the solid line in FIG. 1), or so that the shaft center C of the rotary furnace main unit 8 is in a direction crossing the horizontal line (as shown by an imaginary line in FIG. 1). The control unit 15 is usually housed in a control panel, and input units (for example switches and key boards) and display units (for example LED displays) are provided on the control panel.

The “tilt-drive means” according to the invention is composed of the tilt-drive motor 14 and control unit 15.

The rotary furnace body 4 comprises a large diameter cylinder 16a, a tapered part 16b connected to the large diameter cylinder 16a, and a small diameter cylinder 16c connected to the tapered part 16b and opening port at one end thereof (exemplified as the “opening port” of the invention, and is abbreviated as an opening port 16c). A supporting shaft 16d is provided at another end of the large diameter cylinder 16a. The supporting shaft 16d and opening port 16c of the rotary furnace body 4 are inserted through supporting holes 8b formed at both sides of the heating furnace main unit 8, and are supported with guide rollers 17 by protruding out of the both ends of the heating furnace main unit 8. A rotary motor 19 and a decelerator 20 having a power supply shaft engaged to the driving shaft of the rotary motor 19 via a chain mechanism 21 are mounted on a supporting member 18 provided at the end of the circumference of the heating furnace main unit 8. The tip of the supporting shaft 16d of the rotary furnace body 4 is coupled with the power supply shaft of the decelerator 20 via the chain mechanism 22. Accordingly, the rotary furnace body 4 is rotated in a desired direction of rotation with a desired speed by controlling the rotary motor 19 with the control unit 15.

The “rotary drive means” according to the invention is composed of the rotary motor 19 and the control unit 15.

A cap member 24 for closing the opening port is attached at the opening port 16c of the rotary furnace body 4 so as to be freely attachable and detachable. An exhaust pipe 25 communicating with the inner space of the rotary furnace body 4 is attached at the cap member 24. A connection pipe 26 communicating with a deodorizing device 30 is connected at one end of the exhaust pipe 25 with their shaft center aligned. Another connection pipe (not shown) for communicating with a known refrigerator 27 (shown by an imaginary line in FIG. 1) is provided so as to be connectable at other end of the exhaust pipe 25. A gas feed pipe 28 communicating with the inner space of the rotary furnace body 4 is provided at the supporting shaft 16d of the rotary furnace body 4 so that the pipe is aligned with the shaft. An inert gas such as nitrogen gas is supplied to the gas feed pipe 28.

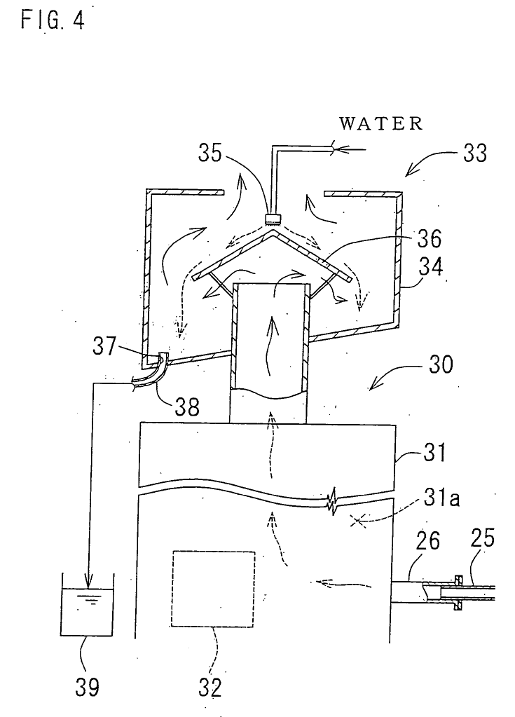

The deodorizing device 30 comprises a vertically elongated cylindrical scavenger 31 in which an exhaust passageway 31a is formed as shown in FIG. 4. The connection pipe 26 (or a cooling pipe constituting the refrigerator 27) is connected to this cylindrical scavenger 31 so as to face the exhaust passageway 31a. The cylindrical scavenger 31 is equipped with a combustion burner 32 (exemplified as the “heating means” according to the invention) for heating the inside of the exhaust passageway 31a. A washing mechanism 33 for washing the exhaust gas with water is provided at the upper end of the cylindrical scavenger 31. This washing mechanism 33 comprises a retrieval box 34 connected to the upper end of the exhaust passageway 31a and open at a part of the upper surface thereof. The retrieval box 34 comprises a sprinkle nozzle 35 to which city water is supplied, and an umbrella member 36 for forming a running water curtain by guiding sprinkled water from the sprinkle nozzle 35 within the retrieval box. An upper end of a retrieval hose 38 is connected to a retrieval hole 37 formed at an inclined bottom plate of the retrieval box 34. The lower end of the retrieval hose 38 is inserted into a retrieval vessel 39 for retrieving the drainage of washing water.

The “drainage retrieval means” according to the invention is composed of the retrieval box 34, retrieval hose 38 and retrieval vessel 39.

A plurality of (four) plate-shaped scratch-up members 6 are welded on the inner circumference of the rotary furnace body 4 along the circumference direction with a given interval (an interval of 45°) as shown in FIGS. 1 and 2. Each scratch-up member 6 comprises a scratch-up part 6a welded at the inner circumference face of the large diameter cylinder 16a, and a crossing part 6b connected to the scratch-up part 6a and welded on the inner circumference face of the tapered part 16b. The scratch-up part 6a is elongated along the shaft center C of the rotary furnace body 4, and functions so as to scratch up the charged material in the rotary furnace body 4 by rotating the rotary furnace body 4. The crossing part 6b is elongated in a direction crossing the shaft center C of the rotary furnace body 4 with a given tilt angle α. The crossing part 6b serves for suppressing the charged material in the large diameter cylinder 16a from moving toward the opening port 16c by rotating the rotary furnace member 4 forward, while activated carbon obtained in the large diameter cylinder 16a is actively guided toward the opening port 16c by inverse rotation of the rotary furnace body 4. The scratch-up member 6 is made of a steel with an alumina coating layer on the surface thereof.

The “scratch-up means” according to the invention is composed of the plural scratch-up members 6.

Both ends of the chain members 7a of the plural scratch-up members 6 are fixed at the scratch-up part 6a of the scratch-up members adjoining along the direction R of rotation of the rotary furnace body 4. Accordingly, the chain member 7a is hung with a given deflection along the shaft center C of the rotary furnace body 4. Each one end of a plurality of (two) chain members 7b is fixed at the scratch-up part 6a of the adjoining another scratch-up members 6 along the shaft center C of the rotary furnace member 4 with a given interval. The chain members 7a and 7b comprise a plurality of sequentially linked metal rings.

The “vibrating means” according to the invention is composed of the plural chain members 7a and 7b.

(2) Function of the Carbonization Plant

The function of the carbonization plant 1 so constructed as described above will be described below. The “charged material” according to the invention refers to the carbonized chips (for example square chips of 1 to 3 mm) made from the waste tire chips (for example square chips of 1 to 3 mm by heating). Activated carbon (a powder with a particle diameter of less than 1 mm) is obtained by heating (activating) the carbonized chips using the carbonization plant 1 in this example.

The carbonized chips before charging is immersed in an aqueous potassium carbonate solution in a preparative step. The aqueous potassium carbonate solution is a drainage retrieved from the deodorizing device 30.

The opening port 16c is made open by removing the cap member 24 from the opening port 16c of the rotary furnace body 4. When an operator sends a charge signal to the control unit 15 by operating a push button, the heating furnace 2 and rotary furnace body 4 are tilted together by controlling the tilting movement by the tilt-drive motor 14 by means of control unit, and the opening port 16c is directed to be aslant upward (as shown by the imaginary line in FIG. 1). Then, the operator charges a given quantity of the carbonized chips (for example 13.5 kg) and a given quantity of potassium carbonate flakes (for example 21 kg) from the opening port 16c of the rotary furnace body 4 into the bottom of the large diameter cylinder 16a. Subsequently, the cap member 24 is fitted at the opening port 16c after tilting the heating furnace 2 and rotary furnace body 4 together so that the opening port 16c is directed in a horizontal direction. The exhaust pipe 25 of the cap member 24 is connected to the cylindrical scavenger 31 of the deodorizing device 30 via the connection pipe 26 to communicate the inner space of the rotary furnace body 4 with the exhaust passageway 31a of the cylindrical scavenger 31.

Subsequently, the inside of the exhaust passageway 31a is heated at a given temperature (for example about 1200° C.) with the combustion burner 32 of the deodorizing device 30. The rotary furnace body 4 is rotated in a desired direction R of rotation and rotation speed by controlling the rotation of the motor 19 with the control unit 15. Nitrogen gas is supplied into the inner space of the rotary furnace body 4 through the gas feed pipe 28. In addition, the heating chamber 8a of the heating furnace 2 is heated at a desired temperature (about 900° C.) by controlling the combustion burner 9 with the control unit 15. Then, the carbonized chips charged in the rotary furnace body 4 are heated in the nitrogen atmosphere after being mixed with potassium hydroxide.

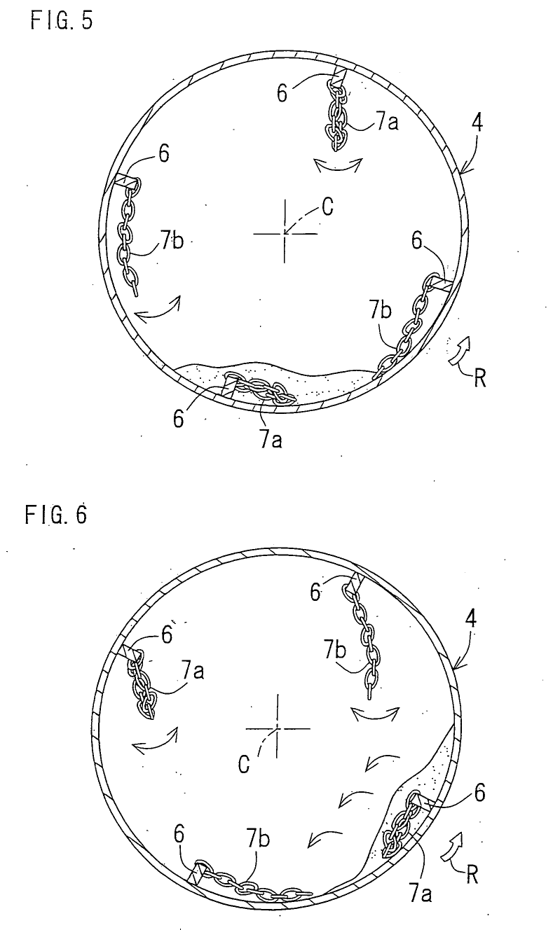

The carbonized chips are scratched up with the scratch-up member 6 as the rotary furnace body 4 is rotated as shown in FIGS. 5 and 6 when the carbonized chips are heated, while the rotary furnace body 4 is vibrated by allowing the chain members 7a and 7b to contact the inner circumference face of the rotary furnace body 4. The carbonized chips scratched up with the scratch-up member 6 falls down toward the bottom by the vibration, and the carbonized chips are sufficiently agitated in the rotary furnace body 4. The scratch-up action of the carbonized chips with the scratch-up member 6 is assisted by a surge movement of the chain member 7b of the chain members 7a and 7b supported at one end (see FIG. 6).

The exhaust gas generated in the rotary furnace body 4 is introduced as shown in FIG. 4, into the exhaust passageway 31a through the exhaust pipe 25 and connection pipe 26, and is heated at the halfway of the exhaust passageway 31a with the combustion burned 32. The heated exhaust gas is emitted into open air through the running water curtain formed by the washing mechanism 33. The drainage used in the washing mechanism 33 is retrieved in the retrieval vessel 39 through the retrieval hose 38, and is recycled as the aqueous potassium carbonate solution for immersing the carbonized chips before charging.

The furnace is cooled thereafter by suspending the operation of the rotary motor 19 and combustion burner 9 when activated carbon is obtained in the rotary furnace body 4. Then, the deodorizing device 30 is disconnected from the exhaust pipe 25, and the cap member 24 is removed from the opening port 16c of the rotary furnace body 4. Then, the heating furnace 2 and rotary furnace body 4 are tiled together by controlling the tilting movement by the tilt-drive motor 14 by means of the control unit 15 to direct the opening port 16c of the rotary furnace body 4 to be aslant downward (as shown by the imaginary line in FIG. 1). Activated carbon in the rotary furnace body 4 is actively lead to the outside through the opening port 16c by being guided by the crossing part 6b of the scratch-up member 6 when the rotary furnace member 4 is rotated in an inverse direction by controlling the rotation of the rotary motor 19 with the control unit 15. Finally, discharged activated carbon (crude activated carbon) is washed and dried to complete a series of the process.

(3) Effect of the Examples

The plural scratch-up members 6 are provided in the rotary furnace body 4 in the carbonization plant 1 of the present invention, and the ends of the chain members 7a and 7b are fixed on the scratch-up member 6. Consequently, the carbonized chips scratched up with the scratch-up member 6 fall down by vibration caused by contact (collision) of the chain members 7a and 7b with the rotary furnace body 4 to enable the carbonized chips to be more reliably agitated by being scratched up in the rotary furnace body 4. Accordingly, activation of the carbonized product is facilitated, bridges of the carbonized product is prevented from being formed while the carbonized product is suppressed from adhering on the inner wall of the rotary furnace, and activated carbon having uniform and good quality can be efficiently produced using the waste tire as a starting material. The entire plant may be constructed with a quite low cost and simple structure, since the rotary furnace body 4 is vibrated by allowing the chain members 7a and 7b to contact the furnace body 4.

Since the heating furnace 2 and rotary furnace body 4 are able to be tilted together at a desired tilt angle (for example 45°, 0° or −45°) by a controlled tilting with the tilt-drive motor 14 in the example, treatments such as charging, heating and discharge of activated carbon can be simply and promptly performed.

The chain member 7a supported at both ends thereof is provided on one of the scratch-up members 6 that is disposed in adjoining relation to the direction R of rotation of the rotary furnace body 4 in this example, while the chain member 7b supported at one end thereof is provided on the other scratch-up member 6. Consequently, a proper intensity of vibration is applied to the rotary furnace body 4 to enable scratch-up efficiency of the carbonized chip to be improved.

The scratch-up member 6 comprises the crossing part 6b elongating in a direction crossing the shaft center C of the rotary furnace body 4 with a given angle a at a position close to the opening port 16c of the rotary furnace body 4 in this example. Consequently, the crossing part 6b permits the carbonized chips to be suppressed from moving toward the opening port 16c during the heating step, and activated carbon is guided toward the opening port 16c side during the discharge step.

The retrieval box 34 for retrieving the drainage after washing with water is provided in the deodorizing device 30 in this example, and the retrieval vessel 39 is connected to the retrieval box 34 through the retrieval hose 38. Consequently, the exhaust gas generated in the heating step of the carbonized chips can be deodorized, while the drainage after washing with water generated in the deodorizing step can be recycled as a potassium carbonate solution for immersing the carbonized chips. Therefore, the amount of use of potassium hydroxide in the heating step of the carbonized chips may be reduced to enable the production cost to be largely lowered.

The invention is not restricted to the example as set forth above, and various modifications are possible depending on the objects and applications within the scope of the invention. While the carbonization plant 1 is used as an activation system in the example, the carbonization plant 1 may be used as a carbonization system. This enables the waste tire chips charged in the rotary furnace body 4 to be converted into the carbonized chips by heating (carbonizing). Nitrogen is not supplied to the gas feed pipe 28 in this case, and the rotary furnace body 4 communicates the deodorizing device 30 via the refrigerator 27 (see FIG. 1). This permits the exhaust gas to be deodorized after retrieving oily components contained in the exhaust gas with the refrigerator 27.

The carbonization plant may be also used as a carbonization and activation system. The carbonized chips are formed by heating the waste tire chips in the rotary furnace body 4, and activated carbon is formed thereafter by mixing the carbonized chips with an alkali metal hydroxide with heating. This process permits the production efficiency to be largely improved as compared with the process by which activated carbon is obtained by using two carbonization plants and an activation plant together.

While this example is constituted by a combination of the chain member 7a supported at both ends thereof and the chain member 7b supported at one end thereof, the invention is not restricted thereto, and all the chain members may be supported at both ends thereof, or at one end thereof. While the chain member 7a supported at both ends thereof and the chain member 7b supported at one end thereof are alternatively aligned along the direction of rotation R of the rotary furnace body 4, the invention is not restricted thereto, and the chain members of the same type may be aligned in adjoining relation to one another.

Looseness of the chain member 7a, and the number of the chain members 7b disposed along the shaft center C of the rotary furnace body 4 may be appropriately changed.

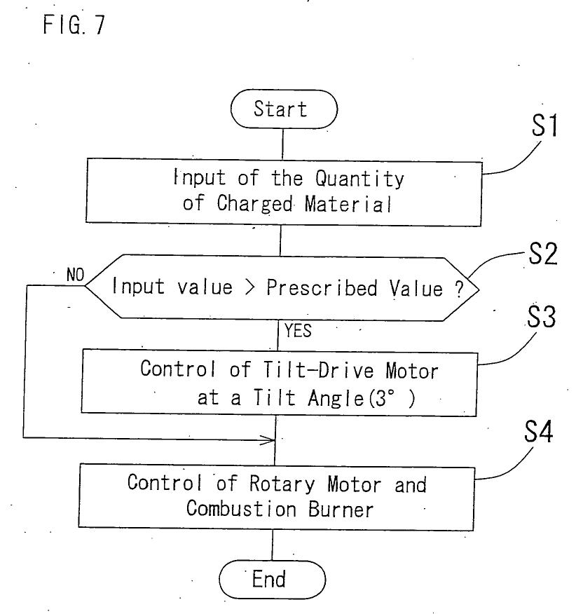

The control unit 15 may comprise the steps of: inputting the data of the charged quantity of the charged material (step S1); comparing the input data with a prescribed value (step S2); controlling the tilt angle of the tilt-drive motor so that the opening port of the rotary furnace body is aslant upward with a tilt angle (about 3°) when the input data exceeds the prescribed data (when the decision is YES in step 2; step S3); and controlling the rotary motor and combustion burner (step 4) as shown in FIG. 7. Step 3 may be skipped when the input data is not larger than the prescribed value (when the decision is NO in step 2), and the process is transferred to step 4.

As industrial applicability, the plant and process of the invention can be applied for producing activated carbon having a uniform and good quality using refuses such as waste tires, waste plastics, waste paper sheets, waste fabrics, waste wood chips and sludge as starting materials.

What is claimed is:

1. A carbonization plant comprising a heating furnace, a rotary furnace body supported in the heating furnace to be freely rotatable, a rotary drive means for rotating the rotary furnace body, and a vibration means for vibrating said rotary furnace body.

2. A carbonization plant comprising a heating furnace, a rotary furnace body supported in the heating furnace to be freely rotatable, a rotary drive means for rotating the rotary furnace body, a scratch-up means provided at an inner face side of said rotary furnace body for scratching up a charged material in the rotary furnace body by rotation of said rotary furnace body, and a vibration means for vibrating said rotary furnace body.

3. The carbonization plant according to claim 2, wherein said heating furnace is supported to be freely tiltable and further comprising a tilt drive means for tilting the heating furnace and said rotary furnace body together.

4. The carbonization plant according to claim 3, wherein said tilt drive means is constructed so that the rotary furnace body is inclinable together with said heating furnace depending on the charged amount of said charged material.

5. The carbonization plant according to claim 2, wherein said vibration means comprises one or a plurality of chain-like members, at least one end thereof being fixed on the inner face side of said rotary furnace body.

6. The carbonization plant according to claim 5, wherein said chain-like members is disposed with a given interval in a direction of rotation of said rotary furnace body,
the one chain-like member of said chain-like members disposed in adjoining relation to one another being supported at one end thereof, and
the other chain-like member of the chain-like members disposed in adjoining relation to one another being supported at both ends thereof.

7. The carbonization plant according to claim 2,
wherein said scratch-up means comprises one or a plurality of scratch-up members having a scratch-up part elongating along a shaft center (C) of said rotary furnace body and a crossing part connected to the scratch-up part and elongating in a direction crossing the shaft center (C) of said rotary furnace body with a given tilt angle (α),
said crossing part being disposed close to an opening port provided at one end of said rotary furnace body.

8. The carbonization plant according to claim 2, wherein said rotary furnace body is formed into a round cylinder.

9. The carbonization plant according to claim 2,
wherein a gas feed pipe elongating along the shaft center (C) of the rotary furnace body is connected at one end of said rotary furnace body for feeding an inert gas, and
wherein one end of an exhaust pipe elongating along the shaft center (C) of the rotary furnace body is connected to the other end of said rotary furnace body for discharging an exhaust gas generated in the rotary furnace body.

10. The carbonization plant according to claim 9 further comprising a deodorizing device connected at the other end of said exhaust pipe for deodorizing said exhaust gas.

11. The carbonization plant according to claim 10, wherein said deodorizing device is connected at the other end of said exhaust pipe through a refrigerator for cooling said exhaust gas.

12. The carbonization plant according to claim 10, wherein said deodorizing device comprises a heating means, a washing mechanism with water for washing said exhaust gas heated with the heating means, and drainage retrieval means for retrieving the drainage issued by washing with water.

13. The carbonization plant according to claim 2, wherein said charged material comprises waste tire chips formed by pulverizing the waste tire, and/or carbonized chips formed by heating the waste tire chips.

14. A carbonization process using the carbonization plant according to claim 1 comprising a heating step for heating charged material in the rotary furnace body by rotating the rotary furnace body in the heating furnace,
said rotary furnace body being vibrated with a vibration means in the heating step.

15. The carbonization process using the carbonization plant according to claim 2 comprising a heating step for heating charged material in the rotary furnace body by rotating the rotary furnace body in the heating furnace,
said charged material being scratched up by a scratch-up means and said rotary furnace body being vibrated with a vibration means in the heating step.

16. The carbonization process according to claim 15 further comprising a step for immersing said charging material in an alkali metal carbonate solution before being charged in said rotary furnace body,
said charged material immersed in said alkali metal carbonate solution being heated by mixing with an alkali metal hydroxide in said rotary furnace body in said heating step, and
said alkali metal carbonate solution being a drainage retrieved after washing an exhaust gas generated in said heating step with water.

17. The carbonization process according to claim 15, wherein a carbonized product is formed by heating said charged material in said rotary furnace body in said heating step, and the carbonized product is converted into activated carbon by mixing with the alkali metal hydroxide with heating.

18. The carbonization process according to claim 15, wherein said charged material comprises the waste tire chips obtained by pulverizing the waste tire, and/or the carbonized chips obtained by heating the waste tire chips.
